(19) United States
(12) Patent Application Publication
(10) Pub. No.: US 2004/0089976 A1
(43) Pub. Date: May 13, 2004

(54) Method and apparatus for constructing an integrally stiffened composite drive shaft

(75) Inventors: Douglas J. Bradley, Howell, MI (US); Brian E. Carlson, Royal Oak, MI (US)

Correspondence Address: Michael A. Massing, BRINKS HOFER GILSON & LIONE, P.O. BOX 10395, CHICAGO, IL, 60610, US

(73) Assignee: Visteon Global Technologies

(21) Appl. No.: 10/681,865

(22) Filed: Oct. 8, 2003

Related U.S. Application Data
(62) Division of application No. 10/017,418, filed on Dec. 14, 2001.

(51) Int. Cl. B29C 70/30

(52) U.S. Cl. 264/258; 425/111

(57) ABSTRACT

There is provided a composite drive shaft fabrication apparatus comprising stiffening mold members and a cylindrical mold with receiving grooves designed to receive the elongated stiffening mold members. Also provided is a composite drive shaft made of composite fibrous material in a cylindrical shape holding the elongated stiffening mold members in place. A method for making the composite drive shaft is also provided, where a layer of composite fibrous material is wrapped around the cylindrical mold, the stiffening mold members inserted, and a second layer wrapped around the mold. The composite drive shaft consolidated and the cylindrical mold is removed. There is also provided an apparatus for use in composite drive shaft construction comprising two layers of composite fibrous material with a plurality of elongated stiffening mold members positioned between them. Also provided is a method of use for such an apparatus.

The present application is a divisional of U.S. patent application Ser. No. 10/017,418, filed on Dec. 14, 2001, and is incorporated by reference in this patent application.

### BACKGROUND OF THE INVENTION

The output of a vehicle transmission is transmitted through a drive shaft to other gears and parts of the drive system. A drive shaft often turns at a very high rate of speed, and is subject to very high torsional forces.

A drive shaft conventionally is made of steel or other metallic substances, which often have disadvantages. For example, in order to provide proper strength to withstand the torsional forces to which it is subjected during use, these shafts often use a dense metal, which requires a large magnitude of power to start and maintain the torsional speed from the transmission. Additionally, metallic components can be fairly expensive.

Lightweight materials have also been used in order to reduce the power needed to start and maintain the torsional speed of the drive shaft. To such end, composite fiber drive shafts have been proposed. Additionally, lightweight materials give the drive shaft a higher critical speed. All drive shaft materials have an internal resonance frequency based in part on the weight of the material. If the drive shaft reaches that material's resonance frequency, the drive shaft will begin to shake. The resonance frequency of the material used thereby determines the top speed of operation, or critical speed, of the drive shaft. A lighter material increases the resonance frequency, and therefore the critical speed, of a drive shaft.

Filament wrapping and fiber braiding methods of creating composite materials have been tested in an attempt to make a stronger composite drive shaft structure able to withstand the torsional forces of vehicle operation. Other materials, such as metallic fibers molded into a composite drive shaft, shaft liners, polyurethane foam molding, and spline groupings cut into the inner surface of a metallic drive shaft, have also been tested. None of these approaches has resulted in an inexpensive drive shaft that has the power advantages of a lightweight material.

### BRIEF SUMMARY OF THE INVENTION

According to one aspect of the present invention, there is provided a composite drive shaft fabrication apparatus comprising at least one elongated stiffening mold member and a cylindrical mold having at least one receiving groove parallel to its central axis designed to receive the elongated stiffening mold member.

According to another aspect of the present invention, there is provided a composite drive shaft comprising a plurality of elongated stiffening mold members arranged parallel to a central axis. Composite fibrous material extending around the elongated stiffening mold members in a cylindrical shape to hold the stiffening mold members in place.

According to yet another aspect of the present invention, there is provided a method for making a composite drive shaft. A cylindrical mold is provided, having a plurality of receiving grooves extending parallel to its axis. A first layer of composite fibrous material is applied around the mold, and elongated stiffening mold members are inserted into the receiving grooves over the first layer of composite material. A second layer of composite fibrous material is applied around the cylindrical mold, the first layer of composite fibrous material, and the elongated stiffening mold members. The assembly is then consolidated into a finished drive shaft and the cylindrical mold is removed from the drive shaft.

According to still another aspect of the present invention, there is provided an apparatus for use in composite drive shaft construction comprising a first layer of composite fibrous material and a plurality of elongated stiffening mold members positioned on the first layer of composite fibrous material. A second layer of composite fibrous material positioned on top of the first layer of composite fibrous material and the elongated stiffening mold members.

According to yet another aspect of the present invention, there is provided another method for making a composite drive shaft. A cylindrical mold is provided having a plurality of receiving grooves extending parallel to its axis. An apparatus for use in making a composite drive shaft is also provided. The apparatus is wrapped around the cylindrical mold so that the elongated stiffening mold members in the apparatus fit into the receiving grooves of the cylindrical mold. The drive shaft is consolidated and the cylindrical mold is removed from the finished drive shaft.

Other aspects of the present invention will become apparent in connection with the following description of the present invention.

### BRIEF DESCRIPTION OF SEVERAL VIEWS OF THE DRAWINGS

FIG. 1A is a cross-sectional view of an embodiment of the cylindrical mold and corresponding stiffening mold member for use in the present invention;

FIG. 1B is a cross-sectional view of another geometry of the cylindrical mold and stiffening mold member of FIG. 1A;

FIG. 1C is a cross-sectional view of another embodiment of the cylindrical mold and stiffening mold member of FIG. 1A;

FIG. 2A is a side view of an embodiment of the cylindrical mold for use in the present invention;

FIG. 2B is a side view of an embodiment of a hat-shaped stiffening mold member for use in the present invention;

FIG. 3 is a side view of another embodiment of the cylindrical mold of FIG. 2A;

FIG. 4 is a cross-sectional view of an embodiment of a completed composite drive shaft according to the present invention;

FIG. 5 is a flow diagram of an embodiment of the composite drive shaft manufacturing process, according to the present invention;

FIG. 6A is a side view of an embodiment of a completed composite drive shaft according to the present invention;

FIG. 6B is a side view of another embodiment of a completed composite drive shaft according to the present invention;

FIG. 7 is a side view of an embodiment of a pre-prepared apparatus for use in the composite drive shaft fabrication method according to the present invention;

FIG. 8 is a flow diagram of an embodiment of a fabrication process for the apparatus of FIG. 7, according to the present invention; and

FIG. 9 is an embodiment of the use of the apparatus of FIG. 8 according to the present invention.

### DETAILED DESCRIPTION OF THE INVENTION

The process of making a composite drive shaft according to the present invention requires a central cylindrical mold 10. The cylindrical mold 10 is shown throughout the figures, but is best viewed in FIG. 2A. According to one embodiment, the cylindrical mold 10 is preferably made of steel or another strong metal to provide structural thickness and support. More specifically, a ¼-inch thick steel has been found to work particularly well in the present invention. Materials that will not adhere to the composite drive shaft, cure during processing of the composite drive shaft, or otherwise self-bond to the composite drive shaft would be an appropriate material for the cylindrical mold 10.

The cylindrical mold 10 also preferably defines at least one receiving groove 12 in the side wall 11 of the cylinder. This receiving groove 12 is preferably cut into the cylindrical mold 10 parallel to its axis. Each receiving groove 12 is preferably configured to receive a stiffening mold member 14.

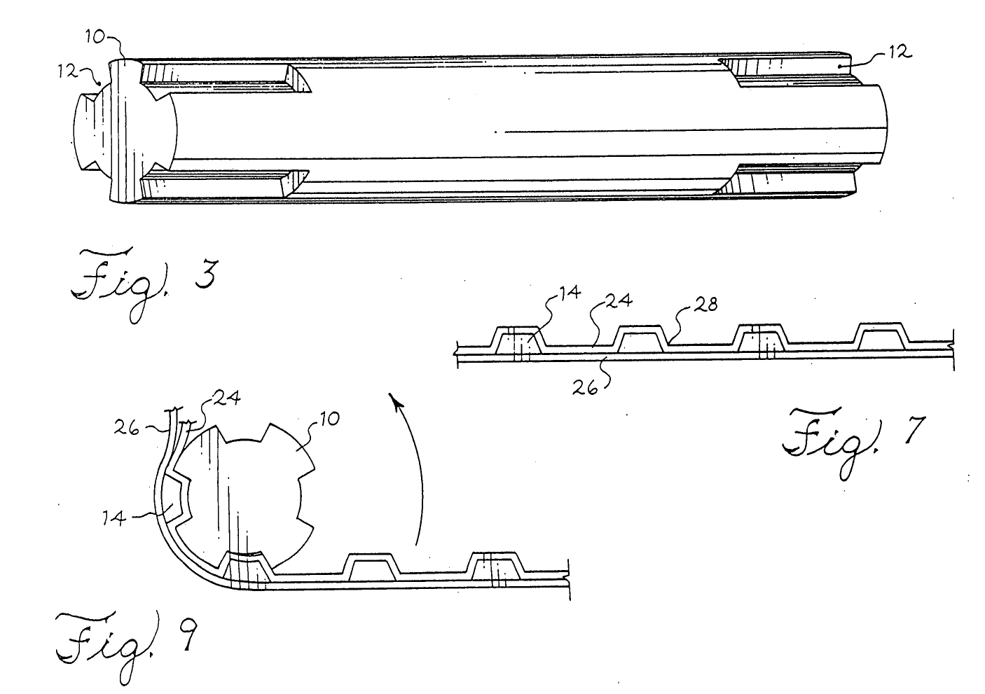

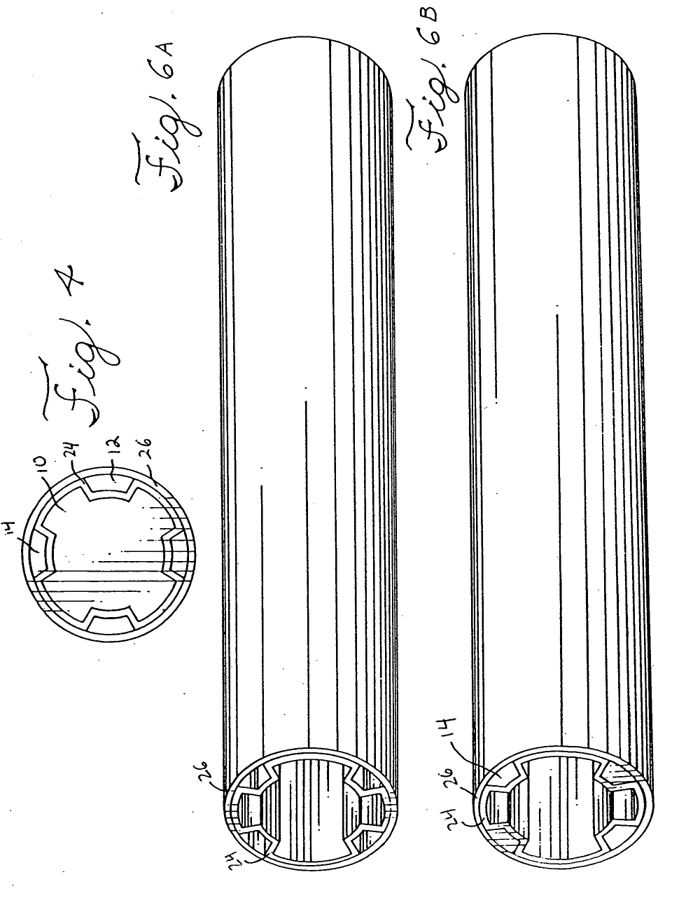

The stiffening mold members 14 serve at least two important functions. The first function is to provide support to the composite drive shaft during construction. As later discussed and as illustrated in FIG. 4, the composite drive shaft comprises two layers of composite material. In the process of constructing the drive shaft, the stiffening mold members 14 provide a separation between the two layers. The stiffening mold members 14 hold these two layers apart as the composite drive shaft is cured, and can then be removed to leave structural voids that strengthen the structure of the composite drive shaft. As the voids are spaced individually around the circumference of the composite drive shaft, the voids provide more strength than would prior art structures, such as a honeycomb arrangement.

Also, the stiffening mold members 14 can themselves be used to provide additional stiffness and strength to the composite drive shaft while in use. As previously stated, the separation of the layers of the drive shaft, effected by the stiffening mold members 14, provides significant additional resistance to torsional forces. Additional stiffness and strength can be supplied if needed by leaving the stiffening mold members 14 in the finished drive shaft.

The stiffening mold members may be made of a wide variety of materials. Polymers such as polypropylene, as well as metallic materials, such as steel and aluminum, have been found to be among ideal materials for embodiments of a stiffening mold member 14.

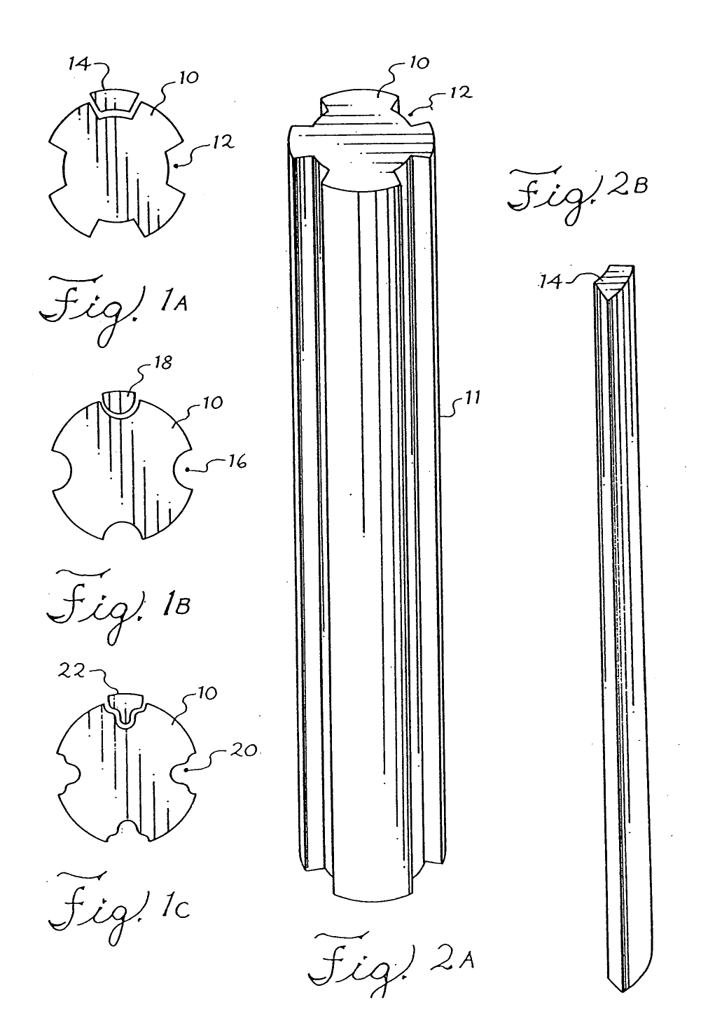

FIGS. 1A through 1C are different embodiments of a cylindrical mold 10 with different shapes of receiving grooves 12, as well as stiffening mold members 14 that correspond with each shape. Three preferred embodiment shapes for the receiving grooves 12 and their associated stiffening mold member 14 are a hat shape, a circular shape, and a T-shape; however, other shapes may be used. FIG. 1A shows a cross-sectional view of an embodiment of a cylindrical mold 10 having a plurality of hat-shaped receiving grooves 12. A hat-shaped stiffening mold member 14 is also shown as it would fit into the receiving groove 12. The hat-shaped stiffening mold members 14 are trapezoidal in cross-sectional shape. Such a shape provides a number of angles and straight sections to improve the rigidity of the composite drive shaft. FIG. 1B shows a variation on the cylindrical mold 10, this time with circular receiving grooves 16. In this embodiment, a circular stiffening mold member 18 is also shown as it could be inserted into the assembly. This shape does not provide the angles of the hat-shaped stiffening mold member 14, but it provides a smoother edge for attaching an end piece while still maintaining an improved rigidity over a uniform composite drive shaft. FIG. 1C shows a third embodiment of the cylindrical mold 10, here portrayed with T-shaped receiving grooves 20 and a T-shaped stiffening mold member 22. The T-shaped receiving grooves provide a ridged structure to the inside of the composite drive shaft that can provide greater rigidity to the drive shaft as well as interface with grooves in an end piece for the drive shaft.

Additionally, silicone rubber or a bladder material can be used to make a stiffening mold member 14. Silicone rubber is a naturally-expanding material, whereas a bladder can expand with the addition of air, like a balloon. These materials can be used where a solid stiffening mold member 14 would normally be used. They can be expanded at any time once the composite drive shaft has been formed around it. The additional pressure supplied by an expanded stiffening mold member 14 to the walls of the composite drive shaft around it will add additional strength to allow the composite drive shaft to withstand torsional stresses in use.

It is important to note that, in order for the present invention to be most effective, the receiving grooves 12 and corresponding stiffening mold members 14 are not of a shape that will permanently lock the cylindrical mold 10 into the composite drive shaft. A preferred composite drive shaft according to the present invention requires the cylindrical mold 10 to be able to slide out of the composite drive shaft. The preferred shapes above all include this ability.

Whereas further figures of this invention portray hat-shaped receiving grooves 12 and stiffening mold members 14, the disclosed invention should be considered generic as to the shape of the receiving grooves 12 and the stiffening mold members 14, and should not be construed as limiting their geometry. Further, terms such as “receiving grooves” and “stiffening mold member”, while portrayed using a certain geometry of receiving grooves or stiffening mold members, should be construed as referring to any geometry, such as hat-shaped, T-shaped, or circular, unless directly specified.

FIGS. 2A and 2B depict side views of embodiments of the cylindrical mold 10 with receiving grooves 12 and a stiffening mold member 14. FIG. 2A illustrates a side view of the cylindrical mold 10, with receiving grooves 12 that extend longitudinally for the full length of the cylindrical mold 10. In the embodiment as shown in FIG. 2A, four hat-shaped receiving grooves 12 are displayed arranged around the circumference of the cylindrical mold 10. There may be more or less such receiving grooves 12 as desired by the manufacturer of the composite drive shaft. The receiving grooves 12 in this embodiment are also arranged equidistantly from each other around the circumference of the cylindrical mold 10. While this is a preferred embodiment for the placement of the receiving grooves 12, the present invention is not limited to equidistant placement—the receiving grooves 12 may be placed anywhere along the circumference of the cylindrical mold 10. Also, this embodiment displays the receiving grooves 12 and the corresponding stiffening mold members 14 as all having the same shape. While a stiffening mold member 14 preferably should have the same general shape as its corresponding receiving groove 12 for the invention to be most effective, not all pairs of receiving grooves 12 and stiffening mold members 14 must have the same shape as each other. It is a preferred embodiment, though, for all pairs to have the same shape. Finally, to provide the highest level of strength and support, it is preferable that these receiving grooves 12 extend parallel to the central axis of the cylindrical mold 10.

It is also not necessary that the receiving grooves 12 run the entire length of the cylindrical mold 10, as illustrated in FIG. 3. In this Figure, the receiving grooves 12 run only a portion of the way through the cylindrical mold 10. To use such a cylindrical mold 10 with the present invention, it would also be necessary to use stiffening mold members 14 of the appropriate size to fit into the receiving grooves 12. A composite drive shaft created with such a cylindrical mold 10 could be used when the strength characteristics are most important at the ends of the drive shaft, or to provide physical support and interlocking means for an end piece for the composite drive shaft. In order to allow the cylindrical mold 10 to be removed from the composite drive shaft when the drive shaft is complete, these receiving grooves 12 should be placed only on one end of the cylindrical mold 10. This placement allows the cylindrical mold 10 to be removed from the other end of the finished composite drive shaft.

The composite drive shaft of the present invention primarily consists of a plurality of layers of composite fibrous material wrapped around the cylindrical mold 10 and the stiffening mold members 14. Such a composite drive shaft, as created around a cylindrical mold 10, is presented in FIG. 4 in a cross-sectional view. A first layer of a composite fibrous material 24 is wrapped around a cylindrical mold 10 with receiving grooves 12. Stiffening mold members 14 are inserted into the receiving grooves 12 over the first layer of composite fibrous material 24. A second layer of composite fibrous material 26 is wrapped around the entire assembly.

The composite fibrous material layers 24 and 26 are preferably composed of one or more carbon fiber sheets each. The carbon fiber sheet is preferably pre-impregnated with composite fibers and resin to facilitate curing of the sheet after wrapping. The carbon fibers used are preferably unidirectional, as that fiber orientation provides the greatest amount of strength. Such a sheet can be obtained commercially, and are available in a variety of thicknesses. A wide range of thicknesses is successful in the present invention. Particular success has been obtained with sheets that are approximately 0.008″ thick.

While a pre-impregnated sheet of composite fibers is a preferred method of applying the layers of composite fibrous material 24 and 26, these layers may also be applied using filament winding or braiding methods. These methods are generally known to those of ordinary skill in the art.

The method of making the composite drive shaft of FIG. 4 is depicted in the flow diagram of FIG. 5. First, a cylindrical mold 10 is provided in box 100 with a plurality of receiving grooves 12. A first layer of composite fibrous material 24 is wrapped around the cylindrical mold 10 in box 110. Stiffening mold members 14 matching the receiving grooves 12 of the cylindrical mold 10 are inserted, in box 120, into said receiving grooves 12 over the first layer of composite fibrous material 24. A second layer of composite fibrous material 26 is then wrapped around the whole assembly in box 130, over the first layer of composite fibrous material 24 and the stiffening mold members 14. The entire assembly is preferably consolidated, or joined together, in box 140, and the cylindrical mold 10 is removed from the center of the drive shaft in box 150.

The consolidation in box 140 may proceed in one of many ways, as known to those of ordinary skill in the art. The consolidation may occur by shrink-wrapping the entire assembly, thus allowing it to cure and adhere together. Such a commercially available shrink-wrap is preferably made of polyester, polyethylene, polypropylene, polyamide polymers, polyimide polymers, other thermoplastic polymers, or a combination of the above. The choice of which polymeric material can be made based on what material is easily available to the manufacturer as well as cost. A vacuum-bag assembly may also be used to consolidate the composite drive shaft using vacuum pressure. In the alternative, a bladder molding assembly or a female mating tool consolidates the assembly via mechanical pressure. The assembly may be treated by a traditional curing process. Other methods of consolidating the assembly, as known to one of ordinary skill in the art, can be chosen based on the materials used, as well as the budget and facilities available to the manufacturer. These methods may also be used to co-cure an endpiece onto the composite drive shaft, as is known to one of ordinary skill in the art.

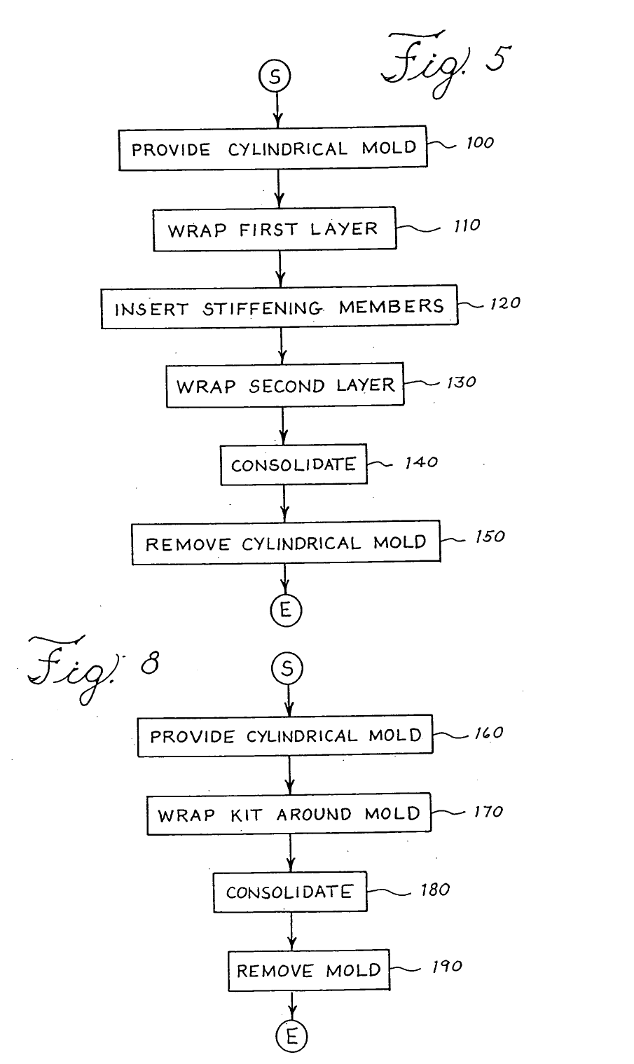

When the cylindrical mold 10 is removed in box 150, the stiffening mold members 14 may also be removed. An embodiment of a finished composite drive shaft without the stiffening mold members 14 is illustrated in FIG. 6A, while another embodiment of a finished composite drive shaft with the stiffening mold members 14 left in the composite drive shaft is shown in FIG. 6B. Whether to leave the stiffening mold members 14 in the finished composite drive shaft can be made based on the material used for the stiffening mold members 14, desired strength characteristics of the finished composite drive shaft, or cost considerations. Additionally, a single set of stiffening mold members 14 can be made and then used in a recyclable fashion, using the same set of stiffening mold members 14 in the formation of a plurality of composite drive shafts.

In order to facilitate ease and speed of creating a composite drive shaft using this method, a pre-prepared apparatus or “kit” can be created. One embodiment of such a kit is shown in FIG. 7. A kit comprises a first layer of composite fibrous material 24 and a second layer of composite fibrous material 26, with a plurality of stiffening mold members 14 integrated between the layers. The stiffening mold members 14 are all arranged parallel to a chosen edge of the first layer of composite fibrous material 24, and placed so as to match up with receiving grooves 12 in a cylindrical mold 10.

It is preferable to add stitching 28 at the edges of the stiffening mold members 14, between the first layer of composite fibrous material 24 and the second layer of composite fibrous material 26. This stitching 28 serves to more securely hold the stiffening mold members 14 in place than partial curing or additional adhesive material. The stitching 28 comprises a thread made of Nylon, Kevlar, or other polyamide, as well as with threads made of polypropylene or polyethylene. A carbon fiber thread may also be used.

The use of such a kit is set forth in the flowchart of FIG. 8. First, the cylindrical mold 10 is provided in box 160. A kit, whose placement of stiffening mold members 14 matches up with the receiving grooves 12 in the cylindrical mold 10, is wrapped around said cylindrical mold 10 in box 170. An illustration of a partially wrapped kit is presented in FIG. 9. After the wrapping step in box 170, the entire assembly is consolidated in box 180. Consolidation in box 180 can be accomplished by any of the methods earlier described for FIG. 5 in box 140 for consolidation of a composite drive shaft without using a kit, or by any other method as known by one of ordinary skill in the art. The cylindrical mold 10 is removed in box 190.

The embodiments shown in the present invention are to be considered as illustrative and not restrictive, and the invention is not to be limited to the details given herein, but may be modified within the scope of the following claims.

1. A composite drive shaft fabrication apparatus comprising:
at least one elongated stiffening mold member; and
a cylindrical mold having at least one receiving groove parallel to its central axis, said receiving groove designed to receive said elongated stiffening mold member.

2. The apparatus of claim 1, wherein said receiving grooves are arranged equidistantly along the circumference of said drive shaft.

3. The apparatus of claim 1, wherein said elongated stiffening mold members and associated receiving grooves have a hat shape.

4. The apparatus of claim 1, wherein said elongated stiffening mold members and associated receiving grooves have a T shape.

5. The apparatus of claim 1, wherein said elongated stiffening mold members and associated receiving grooves have a circular shape.

6. The apparatus of claim 1, wherein said elongated stiffening mold members are removable from the drive shaft to leave structural voids.

7. The apparatus of claim 1, wherein said elongated stiffening mold members and their associated receiving grooves extend longitudinally through the full length of the cylindrical mold.

8. The apparatus of claim 1, wherein said elongated stiffening mold members and their associated receiving grooves extend longitudinally through a portion of the length of the cylindrical mold.

9. A composite drive shaft comprising:
a plurality of elongated stiffening mold members, said elongated stiffening mold members arranged parallel to a central axis; and
composite fibrous material extending around said elongated stiffening mold members in a cylindrical shape to hold said elongated stiffening mold members in place.

10. The composite drive shaft of claim 9, wherein said elongated stiffening mold members have a hat shape.

11. The composite drive shaft of claim 9, wherein said elongated stiffening mold members have a T shape.

12. The composite drive shaft of claim 9, wherein said elongated stiffening mold members have a circular shape.

13. The composite drive shaft of claim 9, wherein said elongated stiffening mold members are removable from the drive shaft to leave structural voids.

14. The composite drive shaft of claim 9, wherein said elongated stiffening mold members extend longitudinally through the full length of the composite drive shaft.

15. The composite drive shaft of claim 9, wherein said elongated stiffening mold members extend longitudinally through a portion of the length of the composite drive shaft.

16. The composite drive shaft of claim 9, wherein said structural voids extend longitudinally through the full length of the composite drive shaft.

17. The composite drive shaft of claim 9, wherein said structural voids extend longitudinally through a portion of the length of the composite drive shaft.

18. A method for making a composite drive shaft, said method comprising the steps of:
providing a cylindrical mold, said cylindrical mold having a plurality of receiving grooves extending parallel to its axis;
applying a first layer of composite fibrous material around said cylindrical mold;
inserting elongated stiffening mold members into said receiving grooves of said cylindrical mold, outside of said first layer of composite fibrous material;
applying a second layer of composite fibrous material around said cylindrical mold, said first layer of composite fibrous material, and said elongated stiffening mold members;
consolidating the drive shaft; and
removing the cylindrical mold from the finished drive shaft.

19. The method of claim 18, further comprising the step of removing the elongated stiffening mold members from the finished drive shaft, leaving structural voids.

20. The method of claim 18, wherein said elongated stiffening mold members and their associated receiving grooves extend longitudinally through the entire length of said cylindrical mold.

21. The method of claim 18, wherein said elongated stiffening mold members and their associated receiving grooves extend longitudinally through only a portion of the length of said cylindrical mold.

22. The method of claim 18, wherein said structural voids extend longitudinally through the entire length of said cylindrical mold.

23. The method of claim 18, wherein said structural voids extend longitudinally through only a portion of the length of said cylindrical mold.

24. The method of claim 18, wherein said receiving grooves and said elongated stiffening mold members are both hat-shaped.

25. The method of claim 18, wherein said receiving grooves and said elongated stiffening mold members are both circular shaped.

26. The method of claim 18, wherein said receiving grooves and said elongated stiffening mold members are both T-shaped.

27. The method of claim 18, wherein the step of applying the first layer of composite fibrous material is accomplished by wrapping at least one pre-impregnated carbon fiber sheet around said cylindrical mold.

28. The method of claim 18, wherein the step of applying the second layer of composite fibrous material is accomplished by wrapping at least one pre-impregnated carbon fiber sheet around said cylindrical mold, said first layer of composite fibrous material, and said elongated stiffening members.

29. An apparatus for use in composite drive shaft construction comprising:
a first layer of composite fibrous material;
a plurality of elongated stiffening mold members, said elongated stiffening mold members positioned on said first layer of composite fibrous material;
and a second layer of composite fibrous material, said second layer of composite fibrous material positioned on said first layer of composite fibrous material and the elongated stiffening mold members.

30. The apparatus of claim 29 wherein the plurality of stiffening mold members are all parallel to the same edge of the first layer of composite fibrous material.

31. The apparatus of claim 29, wherein the edges of said stiffening mold members include stitching extending through both layers of composite fibrous material.

32. The apparatus of claim 29, wherein said elongated stiffening mold members are positioned equidistant from each other.

33. The apparatus of claim 29, wherein said elongated stiffening mold members are hat-shaped.

34. The apparatus of claim 29, wherein said elongated stiffening mold members are T-shaped.

35. The apparatus of claim 29, wherein said elongated stiffening mold members are circular shaped.

36. A method of use for an apparatus for use in making a composite drive shaft, comprising the steps of:
providing a cylindrical mold, said cylindrical mold having a plurality of receiving grooves extending parallel to its axis, and an apparatus for use in making a composite drive shaft;
wrapping said apparatus around said cylindrical mold so that said elongated stiffening mold members in said apparatus fit into said receiving grooves of said cylindrical mold;
consolidating the drive shaft; and
removing said cylindrical mold from the finished drive shaft.

37. The method of claim 36, wherein said receiving grooves and said elongated stiffening mold members are both hat-shaped.

38. The method of claim 36, wherein said receiving grooves and said elongated stiffening mold members are both circular shaped.

39. The method of claim 36, wherein said receiving grooves and said elongated stiffening mold members are both T-shaped.
